(19) United States
(12) Patent Application Publication
(10) Pub. No.: US 2026/0227364 A1
(43) Pub. Date: Aug. 6, 2026

(54) Infiltration Line Measurement System and Method for Tailings Pond

(71) Applicant: CCTEG CHINESE INSTITUTE OF COAL SCIENCE, Beijing (CN)

(72) Inventors: Bo Zhang, Beijing (CN); Wengang Liu, Beijing (CN); Yixiong Gan, Beijing (CN); Weipeng Hao, Beijing (CN); Wende Zhu, Beijing (CN)

(21) Appl. No.: 19/194,214

(22) Filed: Apr. 30, 2025

(30) Foreign Application Priority Data
Feb. 5, 2025 (CN) 202510128135.4

(51) Int. Cl. G01N 29/024

(52) U.S. Cl. CPC G01N 29/024; G01N 2291/011; G01N 2291/02836

(57) ABSTRACT

The present disclose provides an infiltration line measurement system for a tailings pond and an infiltration line measurement method for a tailings pond. The system includes: buried pipes buried in sub-dams, a lower end of each buried pipe being located below the infiltration line of the corresponding sub-dam; signal transmitting units each slidably provided inside the buried pipe and configured for transmitting an acoustic wave signal; signal receiving units each provided on the corresponding sub-dam of the target tailings pond, located above the infiltration line, and configured for receiving the acoustic wave signal; a processing unit configured to determine infiltration line distribution data of the target tailings pond based on acoustic wave signals.

### CROSS-REFERENCE TO RELATED APPLICATIONS

The present application is based on and claims the priority of Chinese patent application No. 2025101281354 filed on Feb. 5, 2025, the entire contents of which are incorporated herein by reference.

### TECHNICAL FIELD

The present disclosure relates to the field of tailings pond monitoring technology, and in particular to an infiltration line measurement system for a tailings pond, and an infiltration line measurement method for a tailings pond.

### BACKGROUND

A tailings pond, used as a storage facility for residues of mineral processing, poses a potential and severe threat to environment. If heavy metals and harmful chemicals in tailings penetrate into groundwater, they could pose significant risks to surrounding ecosystems and human health. An infiltration line, used as an important parameter reflecting liquid content and distribution within the tailings pond, is crucial for predicting and preventing leaks of the tailings pond, and ensuring stability of the tailings pond. Accurate monitoring of the spatial distribution of the infiltration line in the tailings pond is crucial for assessing safety of the tailings pond, optimizing management measures, and preventing environmental pollution.

The position and distribution of the infiltration line directly affect load-bearing capacity and stability of the tailings pond. When the infiltration line is located at a high position of the tailings pond, it indicates that a large amount of water exists in the tailings pile, which increases saturation of the tailings and reduces its shear strength, thereby increasing risks of landslides or collapses occurring in the tailings pond. Understanding the spatial distribution of the infiltration line may help managers to take effective drainage and reinforcement measures, thus improving the stability of the tailings pond. The distribution of the infiltration line determines a flow path and a speed of water within the tailings pond, which directly affects a migration direction and range of potential pollutant. Through spatial destruction monitoring, areas with high penetration risks can be identified promptly, and isolation and purification measures can be taken to minimize the negative impact of the tailings pond on the environmental.

### SUMMARY

The present disclosure aims to solve one of technical problems in the related art at least to some extent.

Accordingly, a first objective of the present disclosure is to provide an infiltration line measurement system for a tailings pond.

A second objective of the present disclosure is to provide an infiltration line measurement method for a tailings pond.

A third objective of the present disclosure is to provide an electronic device.

A fourth objective of the present disclosure is to provide a non-transitory computer-readable storage medium.

A fifth objective of the present disclosure is to provide a computer program product.

In order to achieve the above objectives, a first aspect of embodiments of the present disclosure provides an infiltration line measurement system for a tailings pond. The system includes: buried pipes, signal transmitting units, signal receiving units and a processing unit. The buried pipes have a one-to-one correspondence with sub-dams of a target tailings pond, each buried pipe is buried in a corresponding sub-dam, and a lower end of the buried pipe is located below the infiltration line of the corresponding sub-dam. Each signal transmitting unit is slidably provided inside the buried pipe and configured for transmitting an acoustic wave signal. Each signal receiving unit is provided on the corresponding sub-dam of the target tailings pond, located above the infiltration line of the corresponding sub-dam, and configured for receiving the acoustic wave signal transmitted by the signal transmitting unit. The processing unit is configured for determining infiltration line distribution data of the target tailings pond based on acoustic wave signals uploaded by the signal receiving units.

In order to achieve the above objectives, a third aspect of embodiments of the present disclosure provides an infiltration line measurement method for a tailings pond. The method includes: obtaining infiltration line distribution data of a target tailings pond by measuring the target tailings pond with the infiltration line measurement system for a tailings pond according to the first aspect of embodiments; and generating an infiltration line of the target tailings pond by processing the infiltration line distribution data.

In order to achieve the above objectives, a third aspect of embodiments of the present disclosure provides an electronic device, including at least one processor, and a memory communicatively connected to the at least one processor. The memory stores instructions executable by the at least one processor, and when the instructions are executed by the at least one processor, the infiltration line measurement method for a tailings pond as described in the second aspect of the present disclosure is implemented.

In order to achieve the above objectives, a fourth aspect of embodiments of the present disclosure provides a non-transitory computer-readable storage medium storing computer instructions. The computer instructions are used to implement the infiltration line measurement method for a tailings pond as described in the second aspect of the present disclosure.

In order to achieve the above objectives, a fifth aspect of embodiments of the present disclosure provides a computer program product including a computer program. When the computer program is executed by the processor, the infiltration line measurement method for a tailings pond as described in the second aspect of the present disclosure is implemented.

### BRIEF DESCRIPTION OF THE DRAWINGS

FIG. 1 is a schematic diagram of an infiltration line measurement system for a tailings pond according to an embodiment of the disclosure.

FIG. 2 is a schematic diagram of an infiltration line measurement system for a tailings pond according to an embodiment of the disclosure.

FIG. 3 is a schematic flowchart of a process of determining infiltration line distribution data of a target tailings pond based on acoustic wave signals uploaded by signal receiving units according to an embodiment of the disclosure.

FIG. 4 is a schematic flowchart of a process of determining infiltration line distribution data according to an embodiment of the disclosure.

FIG. 5 is a schematic flowchart of an infiltration line measurement method for a tailings pond according to an embodiment of the present disclosure.

FIG. 6 is a block diagram of an infiltration line measurement apparatus for a tailings pond according to an embodiment of the present disclosure.

FIG. 7 is a block diagram of an electronic device according to an embodiment of the present disclosure.

### DETAILED DESCRIPTION

The following describes the exemplary embodiments of the disclosure with reference to the accompanying drawings, which includes various details of the embodiments of the disclosure to facilitate understanding, which shall be considered merely exemplary. Therefore, those of ordinary skill in the art should recognize that various changes and modifications can be made to the embodiments described herein without departing from the scope and spirit of the disclosure. For clarity and conciseness, descriptions of well-known functions and structures are omitted in the following description.

In the present disclosure, acquisition, storage, use and processing of data comply with the relevant provisions of relevant laws and regulations.

It should be noted that in the embodiments of the present disclosure, some existing solutions such as software, components and models may be mentioned, which should be regarded as exemplary, and are only used to illustrate the feasibility of implementation of the technical solution of the present disclosure. It does not mean that the applicant has or necessarily used the existing solutions.

In the related art, certain monitoring systems have been established for many tailings ponds. However, these systems still fall short in terms of coverage, monitoring items, and data update frequency, etc. Due to the lack of systematic and continuous monitoring, it is difficult to timely grasp dynamic changes of an infiltration line, which affects safety assessment and management of the tailings pond based on a state of the an infiltration line. Moreover, existing methods for monitoring the infiltration line of the tailings pond mainly include physical measurement methods and geophysical methods. Physical measurement methods typically involve drilling, logging, and sampling. These techniques are simple, intuitive, and easy to operate, but have poor timeliness and often take a long time, thereby making it difficult to achieve real-time monitoring of the dynamic changes in the tailings pond. Additionally, their coverage is limited, thus making it hard to conduct comprehensive monitoring over a wide range of tailings pond, but only obtaining one-dimensional or two-dimensional distribution data. Implementations of the physical measurement methods require substantial human and material resources, especially in complex terrains or harsh conditions, so that the costs are high. Geophysical exploration methods (such as resistivity measurement) reduce physical interference to some extent, but have limited sensitivity to water distribution and limited spatial resolution, thus making it difficult to accurately reflect the spatial distribution of the infiltration line.

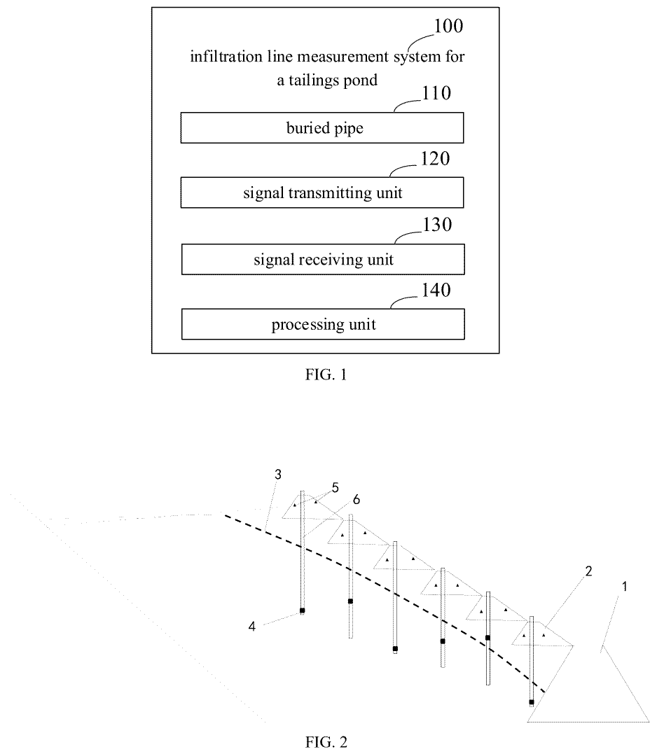

In order to solve the above problems, the present disclosure proposes an infiltration line measurement system for a tailings pond. FIG. 1 is a schematic diagram of an infiltration line measurement system for a tailings pond according to an embodiment of the present disclosure. As shown in FIG. 1, the infiltration line measurement system 100 for a tailings pond includes: buried pipes 110, signal transmitting units 120, signal receiving units 130, and a processing unit 140.

The buried pipes 110 have a one-to-one correspondence with sub-dams of a target tailings pond, each buried pipe 110 is buried in a corresponding sub-dam, and a lower end of the buried pipe 110 is located below the infiltration line of the corresponding sub-dam.

It should be noted that tailings pond is an important facility used by a mining enterprise to store tailings (i.e., waste rock and fine mud after mineral processing) produced during the mineral processing. A typical tailings pond consists of an initial dam and several sub-dams, which together ensure safe storage of the tailings.

In an embodiment of the present disclosure, FIG. 2 is a schematic diagram of an infiltration line measurement system for a tailings pond according to an embodiment of the present disclosure. As shown in FIG. 2, an initial dam of the tailings is indicated by reference numeral 1, a sub-dam is indicated by reference numeral 2, an infiltration line is indicated by reference numeral 3, a signal transmitting unit 120 is indicated by reference numeral 4, a signal receiving unit 130 is indicated by reference numeral 5, and a buried pipe 110 is indicated by reference numeral 6. The tailings pond may include the initial dam and several sub-dams. The initial dam refers to the first permanent water retaining dam constructed during an early construction stage of the tailings pond, which provides a foundation for subsequent tailings accumulation. As the tailings discharge continuously, to increase the pond capacity, the initial dam is gradually raised to form multiple sub-dams. Each newly added sub-dam is referred to as a “lift” or “layer”. A primary function of the sub-dam is to expand the capacity of the tailings pond while maintaining safety and stability of the entire tailings pond. Each sub-dam needs to be able to withstand pressure from the upstream tailings and ensure that landslides or dam failures do not occur under extreme weather conditions (such as heavy rain, earthquakes).

The buried pipe 110 may be a pipe pre-buried during a construction process of the sub-dam, or may be a pipe excavated later, which is not limited herein. It should be noted that the material of the buried pipe 110 may be various, which is not limited herein. For example, the buried pipe 110 may be a PVC pipe.

In an embodiment of the present disclosure, in order to ensure that the lower end of the buried pipe 110 is located below the infiltration line of the corresponding sub-dam, a predetermined burial depth may be set in advance, and the bottom of the buried pipe 110 is positioned below this burial depth. It should be noted that this burial depth is typically a depth value below the infiltration line, which may be obtained through experiments or determined based on technical experiences of the personnel.

The signal transmitting unit 120 is slidably provided inside the buried pipe 110 and used for transmitting an acoustic wave signal.

In an embodiment of the present disclosure, the signal transmitting unit 120 may be a variety of types of signal transmitting apparatuses, which are not limited herein.

It should be noted that in the embodiments of this disclosure, the signal transmitting unit may move up and down within the buried pipe 110 according to actual measurement requirements, to achieve requirements of transmitting acoustic waves from different angles and depths, which may significantly reduce an influence of complex underground environment on measurement and signal transmissions while realizing different test requirements.

The signal receiving unit 130 is provided on the corresponding sub-dam of the target tailings pond and located above the infiltration line of the corresponding to sub-dam, and used for receiving the acoustic wave signal transmitted by the signal transmitting unit 120.

In an embodiment of the present disclosure, as shown in FIG. 2, the signal receiving unit 130 may be provided on an upper part of the sub-dam or at a certain burial depth of the sub-dam, which is not limited herein. In an embodiment of the present disclosure, there may be one signal receiving unit 130 or multiple signal receiving units 130, which is not limited herein and may be determined based on actual design requirements.

The processing unit 140 is used to determine infiltration line distribution data of the target tailings pond based on acoustic wave signals uploaded by the signal receiving units 130.

It should be noted that there may be various types of processing units 140, which is not limited herein. For example, the processing unit 140 may be a processor, or a cloud server with processing functions arranged in the cloud, etc.

With the infiltration line measurement system for a tailings pond, by providing the buried pipe in each sub-dam, and providing the signal transmitting unit slidably inside the buried pipe, an infiltration line position can be calculatedly calibrated, and requirements of transmitting acoustic waves from different angles and depths may be realized, which may greatly reduce an influence of complex underground environment on measurement and signal transmissions. Further, compared to a detection system in the related art, the technical solution of the present disclosure may perform continuous monitoring to realize different test requirements, significantly improve an accuracy and efficiency of monitoring the infiltration line of the tailings pond, reduce detection costs, thus facilitating providing the technical support of safety management and environment protection.

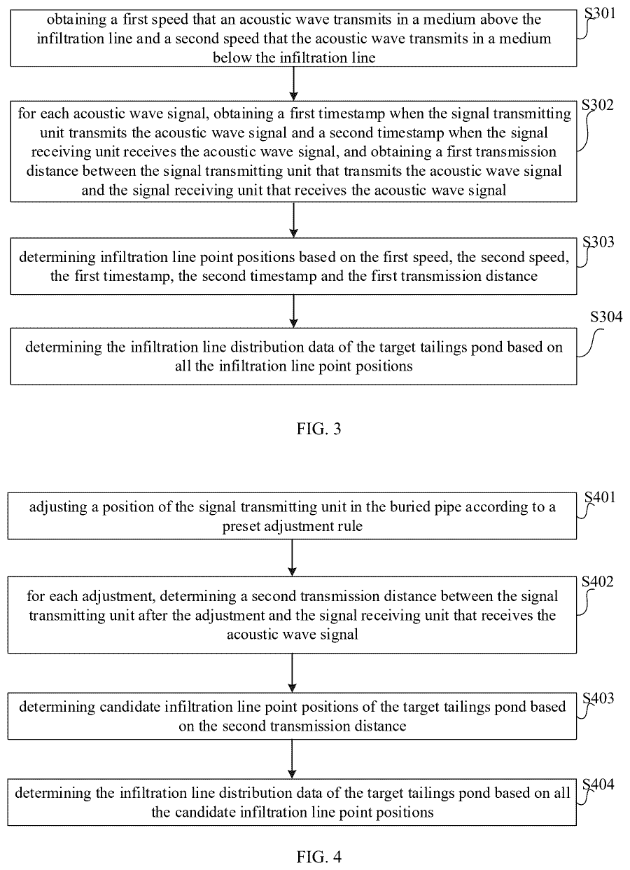

Determining the infiltration line distribution data of the target tailings pond based on the acoustic wave signals uploaded by the signal receiving units in the above embodiment may be further explained with reference to FIG. 3. FIG. 3 is a schematic flowchart of a process of determining the infiltration line distribution data of the target tailings pond based on the acoustic wave signals uploaded by signal receiving units according to an embodiment of the disclosure. The process include the following steps.

At step S301, a first speed that an acoustic wave transmits in a medium above the infiltration line and a second speed that the acoustic wave transmits in a medium below the infiltration line are obtained.

The acoustic wave travels at different speeds in media of varying densities. Therefore, in the embodiments of the present disclosure, the first speed that the acoustic wave transmits in the medium above the infiltration line and the second speed that acoustic wave transmits in the medium below the infiltration line are different. This characteristic allows a position of a point on the infiltration line to be determined through a transmission time of the acoustic wave.

In an embodiment of the present disclosure, the first speed and the second speed may be obtained through experiments. For example, in a laboratory status, samples of the tailings medium to be detected may be taken, and pre-used acoustic wave transmitting apparatuses and acoustic wave receiving apparatuses may be buried within the sampled medium according to a specific position relation. By controlling humidity of the sampled medium, and measuring a propagation time of the acoustic wave between the receiving and transmitting apparatuses under different humidity levels, a relationship between different humidity medium parameters and acoustic wave propagation speeds may be established.

At step S301, for each acoustic wave signal, a first timestamp when the signal transmitting unit transmits the acoustic wave signal and a second timestamp when the signal receiving unit receives the acoustic wave signal are obtained, and a first transmission distance between the signal transmitting unit that transmits the acoustic wave signal and the signal receiving unit that receives the acoustic wave signal is obtained.

In an embodiment of the present disclosure, the signal transmitting unit and the signal receiving unit may be provided with a positioning apparatus. The positions of the signal transmitting unit and the signal receiving unit may be determined by the positioning apparatus, so as to the first transmission distance between the signal transmitting unit and the signal receiving unit may be further determined.

At step S303, infiltration line point positions are determined based on the first speed, the second speed, the first timestamp, the second timestamp and the first transmission distance.

In an embodiment of the present disclosure, after obtaining the first speed, the second speed, the first timestamp, the second timestamp, and the first transmission distance, a distance between the infiltration line point position and the signal receiving unit and a distance between the infiltration line point position and the signal transmitting unit may be calculated using a preset algorithm. Based on coordinates of the signal receiving unit and the signal transmitting unit, as well as their respective distances, the infiltration line point position may be determined.

At step S304, the infiltration line distribution data of the target tailings pond is determined based on all the infiltration line point positions.

In an embodiment of the present disclosure, first, the first speed that the acoustic wave transmits in the medium above the infiltration line and the second speed that the acoustic wave transmits the medium below the infiltration line are obtained. Then, for any acoustic wave signal, the first timestamp when the signal transmitting unit transmits the acoustic wave signal and the second timestamp when the signal receiving unit receives the acoustic wave signal are obtained. The first transmission distance between the signal transmitting unit transmitting the acoustic wave signal and the signal receiving unit receiving the acoustic wave signal is obtained. Based on the first speed, the second speed, the first timestamp, the second timestamp, and the first transmission distance, the infiltration line point positions are determined. Finally, based on all the infiltration line point positions, the infiltration line distribution data of the target tailings pond is determined. Thus, by using precise timestamps, transmission distances, and acoustic wave speeds to determine the specific location of the infiltration line, the infiltration line distribution of the entire tailings pond may be determined, which not only improves monitoring accuracy but also provides reliable data support for the safety management of the tailings pond. Compared to traditional methods such as drilling and sampling, non-contact acoustic wave measurement avoids data distortion caused by disturbances during the sampling process, thereby providing more accurate and reliable infiltration line data.

FIG. 4 is a schematic flowchart of a process of determining infiltration line distribution data according to an embodiment of the disclosure. Determining the infiltration line distribution data in the above embodiment may be further explained with reference to FIG. 4, which includes the following steps.

At step S401, a position of the signal transmitting unit in the buried pipe is adjusted according to a preset adjustment rule.

In an embodiment of the present disclosure, there may be various preset adjustment rules, which is not limited herein. In a possible implementation, the preset adjustment rule may be adjusting upward or downward by a certain distance according to an adjustment period.

Optionally, the preset adjustment rule may also be adjusting between two positions at a preset time interval. For example, the signal transmitting unit is located at position a at the current timestamp, and adjusted from position a to position b at the next timestamp, and then the signal transmitting unit transmits acoustic waves subsequently between position a and position b.

At step S402, for each adjustment, a second transmission distance between the signal transmitting unit after the adjustment and the signal receiving unit that receives the acoustic wave signal is determined.

At step S403, candidate infiltration line point positions of the target tailings pond are determined based on the second transmission distance.

In an embodiment of the present disclosure, since the position of the signal receiving unit is fixed, when the position of the signal transmitting unit changes, the second transmission distance changes and a new candidate infiltration line point position may be determined.

By adjusting the signal transmitting unit, multiple candidate infiltration line point positions may be collected to improve the subsequent process.

At step S404, the infiltration line distribution data of the target tailings pond is determined based on all the candidate infiltration line point positions.

In an embodiment of the present disclosure, there may be various methods for determining the infiltration line distribution data based on all the candidate infiltration line point positions, which is not limited herein. In a possible implementation, a preset fitting algorithm may be used to calculate all the candidate infiltration line point positions to generate the infiltration line distribution data of the target tailings pond.

In another possible implementation, all the candidate infiltration line point positions may be input into an infiltration line generation model to generate the infiltration line distribution data of the target tailings pond. This infiltration line generation model is pre-trained and may be stored in a storage space of an electronic device for easy retrieval and usage as needed.

In an embodiment of the present disclosure, first, the position of the signal transmitting unit in the buried pipe is adjusted according to the preset adjustment rule. Then, for any adjustment, the second transmission distance between the signal transmitting unit after the adjustment and the signal receiving unit that receives the acoustic wave signal is determined. Based on the second transmission distance, the candidate infiltration line point positions of the target tailings pond are determined. Finally, based on all the candidate infiltration line point positions, the infiltration line distribution data of the target tailings pond is determined. By dynamically adjusting the position of the signal transmitting unit and combining with data from the receiving unit, candidate infiltration line point positions may be determined, and the infiltration line distribution map may be drawn. This method not only improves flexibility and accuracy of monitoring but also provides more reliable data support for the safety management of tailings pond.

In an embodiment of the present disclosure, the signal receiving unit is also used to screen out an acoustic wave signal with a signal strength less than a strength threshold. In this way, the accuracy of subsequent data processing may be ensured.

It should be noted that the strength threshold is designed in advance and may be changed according to actual measurement requirements, which is not limited herein.

In an embodiment of the present disclosure, a clock of the signal transmitting unit and a clock the signal receiving unit are synchronized. In a possible implementation, the signal transmitting unit and the signal receiving unit are connected via a synchronous clock line to ensure that the signal receiving unit may start timing from a moment when the signal transmitting unit transmits, thereby accurately calculating the propagation time of the acoustic wave in the tailings medium.

In an embodiment of the present disclosure, acoustic wave transmitting frequencies of all the signal transmitting units are different. Thus, the acoustic wave sources may be distinguished by the acoustic wave transmitting frequencies, which provides a data basis for subsequent determination of the candidate infiltration line point positions.

In an embodiment of the present disclosure, each signal transmitting unit is provided with a displacement pulley and a motor, an output end of the motor is connected to an enable end of the displacement pulley, and each buried pipe is provided with a sliding rail cooperating with the displacement pulley for sliding.

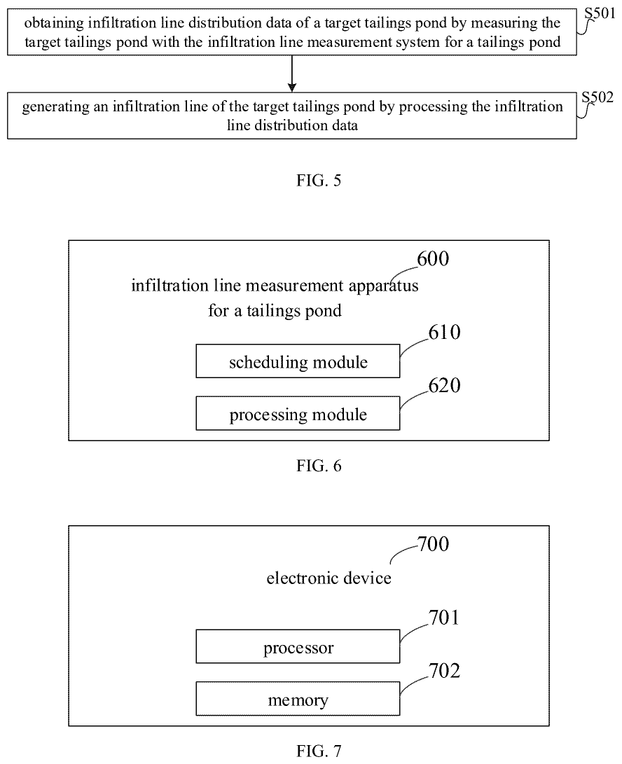

FIG. 5 is a schematic flowchart of an infiltration line measurement method for a tailings pond according to an embodiment of the present disclosure. As shown in FIG. 5, the method includes the following steps.

At step S501, infiltration line distribution data of a target tailings pond is obtained by measuring the target tailings pond with the infiltration line measurement system for a tailings pond.

It should be noted that the infiltration line measurement system for a tailings pond in this embodiment is the infiltration line measurement system for a tailings pond shown in embodiments of FIG. 1-FIG. 4. The specific measurement method may refer to the above embodiments, which will not be repeated here.

At step S502, an infiltration line of the target tailings pond is generated by processing the infiltration line distribution data.

In an embodiment of the present disclosure, after obtaining the infiltration line of the target tailings pond, an effective reference may be provided for the design and operation of the target tailings pond based on the infiltration line.

During the design, by measuring and obtaining the infiltration line distribution, the tailings pond may be optimized to select more reasonable structure and impermeable materials, thereby increasing the safe storage capacity of the tailings pond. During the operation, by adjusting a discharge strategy and water control measures of the tailings pond according to dynamic changes in the infiltration line, the capacity and safety of the tailings pond may be effectively managed. During the closure, understanding the infiltration line distribution helps formulate a more scientific closure plan, thus ensuring long-term stability.

In an embodiment of the present disclosure, after obtaining the infiltration line of the target tailings pond, the infiltration line may be compared with a preset alarm line, and then an alarm event is generated based on a curve segment when it is identified that the infiltration line has the curve segment located below the alarm line.

In a possible implementation, the coordinates of the curve segment may be determined to determine the position of the curve segment on the tailings pond, so that the alarm event corresponding to the position may be generated and sent to the corresponding maintenance personnel for further verification or corresponding measures.

Corresponding to the infiltration line measurement method for a tailings pond provided in the above embodiments, the embodiments of the present disclosure also provides an infiltration line measurement apparatus for a tailings pond. Since the infiltration line measurement apparatus for a tailings pond provided in the embodiments of the disclosure corresponds to the infiltration line measurement method for a tailings pond provided in the above embodiments, the implementation methods of the aforementioned infiltration line measurement method for a tailings pond are also applicable to the infiltration line measurement apparatus for a tailings pond provided in the embodiments of the present disclosure, and will not be described in detail in the following embodiments.

FIG. 6 is a block diagram of an infiltration line measurement apparatus for a tailings pond according to an embodiment of the present disclosure. As shown in FIG. 6, the infiltration line measurement apparatus 600 for a tailings pond includes a scheduling module 610 and a processing module 620.

The scheduling module 610 is configured to obtain infiltration line distribution data of a target tailings pond by measuring the target tailings pond with the infiltration line measurement system for a tailings pond.

The processing module 620 is configured to generate an infiltration line of the target tailings pond by processing the infiltration line distribution data.

In an embodiment of the present disclosure, the apparatus is further configured to: compare the infiltration line with a preset alarm line; and in response to recognizing that the infiltration line has a curve segment located below the preset alarm line, generate an alarm event based on the curve segment.

In order to implement the above embodiments, the embodiments of the present disclosure provide an electronic device 700. FIG. 7 is a block diagram of an electronic device according to an embodiment of the present disclosure. As shown in FIG. 7, the electronic device 700 includes a processor 701, and a memory 702 communicatively connected to the processor. The memory 702 stores instructions executable by the at least one processor, and when the instructions are executed by the at least one processor 701, the infiltration line measurement method for a tailings pond as described in the embodiment of FIG. 5 is implemented.

In order to implement the above embodiments, the embodiments of the present disclosure provide a non-transitory computer-readable storage medium storing computer instructions. The computer instructions are used to cause a computer to implement the infiltration line measurement method for a tailings pond as described in the embodiment of FIG. 5.

In order to implement the above embodiments, the embodiments of the present disclosure provide a computer program product including a computer program. When the computer program is executed by the processor, the infiltration line measurement method for a tailings pond as described in the embodiment of FIG. 5 is implemented.

It should be noted that personal information from users should be collected for legal and reasonable purposes and not shared or sold outside of these legitimate uses. Furthermore, such collection/sharing activities may only occur after obtaining the user's informed consent, including but not limited to notifying the user to read the user agreement/user notification before using the function, and signing an agreement/authorization that authorizes the use of relevant user information. Additionally, any necessary steps must be taken to protect and safeguard access, to such personal information data, and ensure that others with access to the personal information data comply with their privacy policies and procedures.

The present disclosure is expected to provide users with an implementation for selectively blocking the use or access of personal information data. That is, the present disclosure is intended to offer hardware and/or software to prevent or block access to such personal information data. Once personal information data is no longer needed, risks may be minimized by limiting data collection and deleting data. Additionally, when applicable, personal identifiers are removed from such personal information to protect user privacy.

In the foregoing description of various embodiments, references to terms such as “an embodiment”, “some embodiments”, “example”, “specific example” or “some examples” indicate that specific features, structures, materials, or characteristics described in conjunction with the embodiment or example are included in at least one embodiment or example of the present disclosure. In this specification, the illustrative use of these terms does not necessarily refer to the same embodiment or example. Moreover, the specific features, structures, materials, or characteristics described may be combined in any suitable manner in one or more embodiments or examples. Furthermore, without contradiction, those skilled in the art may combine and integrate different embodiments or examples described in this specification, as well as the features of different embodiments or examples.

In addition, the terms “first” and “second” are used only for descriptive purposes and should not be interpreted as indicating or implying relative importance or implicitly specifying the number of technical features indicated. Therefore, features limited by “first” or “second” can explicitly or implicitly include at least one such feature. In the description of the present disclosure, the term “multiple” means at least two, such as two, three, etc., unless otherwise specifically defined.

The description of any process or method depicted in the flowchart or otherwise herein can be understood as representing a module, fragment, or part of code that includes one or more executable instructions for implementing custom logic functions or processes. The preferred embodiments of the present disclosure include additional implementations, where functions can be performed in a substantially simultaneous manner or in reverse order according to the involved functionalities, without necessarily following the sequence shown or discussed. This should be understood by those skilled in the art to which the embodiments of the present disclosure belong.

The logic and/or steps represented in the flowchart or described herein can be considered as a sequence of executable instructions for implementing logical functions. These can be embodied in any computer-readable medium for use by an instruction execution system, device, or apparatus (such as a computer-based system, a system including a processor, or other systems that can take and execute instructions from an instruction execution system, device, or apparatus), or in conjunction with these instruction execution systems, devices, or apparatuses. For the purposes of this specification, “computer-readable medium” can refer to any device that contains, stores, communicates, transmits, or otherwise delivers programs for use by an instruction execution system, device, or apparatus, or in conjunction with such systems, devices, or apparatuses. More specific examples of computer-readable media (not exhaustive list) include: electrical connection parts with one or more wiring (electronic devices), portable computer disk drives (magnetic devices), random access memory (RAM), read-only memory (ROM), erasable programmable read-only memory (EPROM or flash memory), optical fiber devices, and portable optical disc read-only memory (CD-ROM). Additionally, computer-readable media can even be paper or other suitable media on which the program can be printed, as the program can be obtained electronically by, for example, optical scanning of paper or other media, followed by editing, interpretation, or processing as necessary in other appropriate ways, and then stored in a computer memory.

It should be understood that various parts of the present disclosure can be implemented using hardware, software, firmware, or combinations thereof. In the aforementioned embodiments, multiple steps or methods can be realized through software or firmware stored in memory and executed by a suitable instruction execution system. For example, if implemented using hardware, as in another embodiment, any one or combination of the following techniques known to those skilled in the art can be used: discrete logic circuits with logic gate circuits for implementing logical functions on data signals, application-specific integrated circuits with appropriate combinational logic gate circuits, programmable gate arrays (PGAs), field-programmable gate arrays (FPGAs), etc.

A person skilled in the art of this technical field can understand that all or part of the steps carried by the above embodiments can be completed by instructing the related hardware through a program, and the program can be stored in a computer-readable storage medium, which includes one or a combination of the steps of the embodiment when executed.

In addition, in various embodiments of the present disclosure, each functional unit can be integrated into a processing module, or each unit can exist physically separately, or two or more units can be integrated into one module. The integrated modules can be implemented either in hardware form or as software function modules. If the integrated modules are implemented as software function modules and sold or used as independent products, they can also be stored on a computer-readable storage medium.

The storage medium mentioned above may be read only memory, disk or optical disc, etc.

What is claimed is

1. An infiltration line measurement system for a tailings pond, comprising:
buried pipes, signal transmitters, signal receivers and a processor, wherein the buried pipes have a one-to-one correspondence with sub-dams of a target tailings pond, each buried pipe is buried in a corresponding sub-dam, and a lower end of the buried pipe is located below the infiltration line of the corresponding sub-dam;
each of said signal transmitters is slidably provided inside a corresponding one of the buried pipes and is configured for transmitting an acoustic wave signal;
each of said signal receivers is provided on the corresponding sub-dam of the target tailings pond, located above the infiltration line of the corresponding sub-dam, and is configured for receiving the acoustic wave signal transmitted by a corresponding one of the signal transmitters;
the processor is configured to determine infiltration line distribution data of the target tailings pond based on acoustic wave signals uploaded by the signal receivers, wherein the processor is configured to:
obtain a first speed that an acoustic wave transmits in a medium above the infiltration line and a second speed that the acoustic wave transmits in a medium below the infiltration line;
for each acoustic wave signal, obtain a first timestamp when the signal transmitter transmits the acoustic wave signal and a second timestamp when the signal receiver receives the acoustic wave signal, and obtain a first transmission distance between the signal transmitter that transmits the acoustic wave signal and the signal receiver that receives the acoustic wave signal;
determine infiltration line point positions based on the first speed, the second speed, the first timestamp, the second timestamp and the first transmission distance; and
determine the infiltration line distribution data of the target tailings pond based on all the infiltration line point positions.

2. The system according to claim 1, wherein the system is further configured to:
adjust a position of the signal transmitter in the buried pipe according to a preset adjustment rule;
for each adjustment, determine a second transmission distance between the signal transmitter after the adjustment and the signal receiver that receives the acoustic wave signal;
determine candidate infiltration line point positions of the target tailings pond based on the second transmission distance; and
determine the infiltration line distribution data of the target tailings pond based on all the candidate infiltration line point positions.

3. The system according to claim 1, wherein the signal receiver is further configured to screen out an acoustic wave signal whose signal strength is less than a strength threshold.

4. The system according to claim 2, wherein the signal receiver is further configured to screen out an acoustic wave signal whose signal strength is less than a strength threshold.

5. The system according to claim 1, wherein a clock of the signal transmitter and a clock of the signal receiver are synchronized.

6. The system according to claim 2, wherein a clock of the signal transmitter and a clock of the signal receiver are synchronized.

7. The system according to claim 1, wherein acoustic wave transmitting frequencies of all the signal transmitters are different.

8. The system according to claim 1, wherein each signal transmitter is provided with a displacement pulley and a motor, an output end of the motor is connected to an enable end of the displacement pulley, and each buried pipe is provided with a slide rail cooperating with the displacement pulley for sliding.

9. An infiltration line measurement method for a tailings pond, comprising:
obtaining infiltration line distribution data of a target tailings pond by measuring the target tailings pond with an infiltration line measurement system for a tailings pond; and
generating an infiltration line of the target tailings pond by processing the infiltration line distribution data;
wherein the infiltration line measurement system for a tailings pond comprises buried pipes, signal transmitters, signal receivers and a processor;
wherein each of the buried pipes has a one-to-one correspondence with sub-dams of the target tailings pond, each of the buried pipes is buried in a corresponding sub-dam, and a lower end of each of the buried pipes is located below the infiltration line of the corresponding sub-dam;
each of the signal transmitters is slidably provided inside a corresponding one of the buried pipes and is configured for transmitting an acoustic wave signal;
each of the signal receivers is provided on the corresponding sub-dam of the target tailings pond, located above the infiltration line of the corresponding sub-dam, and is configured for receiving the acoustic wave signal transmitted by a corresponding one of the signal transmitters;
the processor is configured to determine the infiltration line distribution data of the target tailings pond based on acoustic wave signals uploaded by the signal receivers, wherein the processor is configured to:
obtain a first speed that an acoustic wave transmits in a medium above the infiltration line and a second speed that the acoustic wave transmits in a medium below the infiltration line;
for each acoustic wave signal, obtain a first timestamp when the signal transmitter transmits the acoustic wave signal and a second timestamp when the signal receiver receives the acoustic wave signal, and obtain a first transmission distance between the signal transmitter that transmits the acoustic wave signal and the signal receiver that receives the acoustic wave signal;
determine infiltration line point positions based on the first speed, the second speed, the first timestamp, the second timestamp and the first transmission distance; and
determine the infiltration line distribution data of the target tailings pond based on all the infiltration line point positions.

10. The method according to claim 9, further comprising:
comparing the infiltration line with a preset alarm line; and
in response to recognizing that the infiltration line has a curve segment located below the preset alarm line, generating an alarm event based on the curve segment.

11. The method according to claim 9, further comprising:
adjusting a position of the signal transmitter in the buried pipe according to a preset adjustment rule;
for each adjustment, determining a second transmission distance between the signal transmitter after the adjustment and the signal receiver that receives the acoustic wave signal;
determining candidate infiltration line point positions of the target tailings pond based on the second transmission distance; and
determining the infiltration line distribution data of the target tailings pond based on all the candidate infiltration line point positions.

12. The method according to claim 9, wherein the signal receiver is further configured to screen out an acoustic wave signal whose signal strength is less than a strength threshold.

13. The method according to claim 9, wherein a clock of the signal transmitter and a clock of the signal receiver are synchronized.

14. The method according to claim 9, wherein acoustic wave transmitting frequencies of all the signal transmitters are different.

15. The method according to claim 9, wherein each signal transmitter is provided with a displacement pulley and a motor, an output end of the motor is connected to an enable end of the displacement pulley, and each buried pipe is provided with a slide rail cooperating with the displacement pulley for sliding.

16. An electronic device, comprising:
a memory and a first processor;
wherein the first processor is configured to read executable program codes stored in the memory and execute a program corresponding to the executable program codes to perform:
obtaining infiltration line distribution data of a target tailings pond by measuring the target tailings pond with an infiltration line measurement system for a tailings pond; and
generating an infiltration line of the target tailings pond by processing the infiltration line distribution data;
wherein the infiltration line measurement system for a tailings pond comprises buried pipes, signal transmitters, signal receivers and a second processor;
wherein the buried pipes have a one-to-one correspondence with sub-dams of the target tailings pond, each buried pipe is buried in a corresponding sub-dam, and a lower end of the buried pipe is located below the infiltration line of the corresponding sub-dam;
each signal transmitter is slidably provided inside the buried pipe and configured for transmitting an acoustic wave signal;
each signal receiver is provided on the corresponding sub-dam of the target tailings pond, located above the infiltration line of the corresponding sub-dam, and configured for receiving the acoustic wave signal transmitted by the signal transmitter;
the second processor is configured to determine the infiltration line distribution data of the target tailings pond based on acoustic wave signals uploaded by the signal receivers;
wherein the second processor is configured to:
obtain a first speed that an acoustic wave transmits in a medium above the infiltration line and a second speed that the acoustic wave transmits in a medium below the infiltration line;
for each acoustic wave signal, obtain a first timestamp when the signal transmitter transmits the acoustic wave signal and a second timestamp when the signal receiver receives the acoustic wave signal, and obtain a first transmission distance between the signal transmitter that transmits the acoustic wave signal and the signal receiver that receives the acoustic wave signal;
determine infiltration line point positions based on the first speed, the second speed, the first timestamp, the second timestamp and the first transmission distance; and
determine the infiltration line distribution data of the target tailings pond based on all the infiltration line point positions.

17. The electronic device according to claim 16, wherein the first processor is further configured to:
compare the infiltration line with a preset alarm line; and
in response to recognizing that the infiltration line has a curve segment located below the preset alarm line, generate an alarm event based on the curve segment.

18. The electronic device according to claim 16, wherein the system is further configured to:
adjust a position of the signal transmitter in the buried pipe according to a preset adjustment rule;
for each adjustment, determine a second transmission distance between the signal transmitter after the adjustment and the signal receiver that receives the acoustic wave signal;
determine candidate infiltration line point positions of the target tailings pond based on the second transmission distance; and
determine the infiltration line distribution data of the target tailings pond based on all the candidate infiltration line point positions.

19. The electronic device according to claim 16, wherein the signal receiver is further configured to screen out an acoustic wave signal whose signal strength is less than a strength threshold.

20. The electronic device according to claim 16, wherein a clock of the signal transmitter and a clock of the signal receiver are synchronized.
